(19) United States
(12) Patent Application Publication
(10) Pub. No.: US 2025/0015642 A1
(43) Pub. Date: Jan. 9, 2025

(54) STATOR AND A MOTOR INCLUDING THE SAME

(71) Applicants: HYUNDAI MOTOR COMPANY, Seoul (KR); KIA CORPORATION, Seoul (KR)

(72) Inventors: Bong Hee Lee, Seongnam-si (KR); Shin Gyu Kim, Hwaseong-si (KR)

(73) Assignees: HYUNDAI MOTOR COMPANY, Seoul (KR); KIA CORPORATION, Seoul (KR)

(21) Appl. No.: 18/531,388

(22) Filed: Dec. 6, 2023

(30) Foreign Application Priority Data
Jul. 3, 2023 (KR) 10-2023-0085690

(51) Int. Cl. H02K 1/02; H02K 1/18

(52) U.S. Cl. CPC H02K 1/02; H02K 1/182; H02K 2213/03

(57) ABSTRACT

A motor having a stator is disclosed. The stator includes a stator core at least partially formed of an anisotropic material.

### CROSS-REFERENCE TO RELATED APPLICATION

This application claims, under 35 U.S.C. § 119(a), the benefit of and priority to Korean Patent Application No. 10-2023-0085690, filed on Jul. 3, 2023, the entire contents of which are incorporated herein by reference.

### TECHNICAL FIELD

The present disclosure relates to a motor.

### BACKGROUND

An electric vehicle (EV) is a vehicle driven by a motor. The EV has recently received a lot of attention due to an eco-friendly aspect thereof. With the growth of the EV market, research and development have been actively conducted on a motor having high efficiency and output.

A motor may generally be an axial flux motor or a radial flux motor. Magnetic flux of the radial flux motor is formed in the radial direction of a motor, whereas magnetic flux of the axial flux motor is formed in parallel with the rotation axis of the motor.

The radial flux motor has been mainly used in the EV. Recently, the axial flux motor has been aggressively developed from the viewpoint of improving torque density of the axial flux motor and efficiency thereof.

The above information disclosed in this Background section is provided only to enhance understanding of the background of the disclosure. Therefore, the Background section may contain information that does not form the prior art that is already known to a person of ordinary skill in the art.

### SUMMARY

The present disclosure has been made in an effort to solve the above-described problems associated with the prior art. It is an object of the present disclosure to provide an axial flux motor having improved efficiency.

The objects of the present disclosure are not limited to the above-mentioned object. Other technical objects not mentioned herein should be clearly understood by those having ordinary skill in the art to which the present disclosure pertains from the detailed description of the embodiments.

In one aspect, the present disclosure provides a stator of a motor. The stator includes a stator core at least partially formed of an anisotropic material.

In another aspect, the present disclosure provides an axial flux motor including a rotor. The rotor includes a plurality of permanent magnet. The axial flux motor also includes a stator disposed in an axial direction of the rotor and the axial flux motor. The stator includes a stator core having a coil mounted thereon. The stator core is at least partially formed of an anisotropic material.

The above and other aspects and embodiments of the disclosure are discussed below.

It should be understood that the terms “vehicle”, “vehicular”, and other similar terms as used herein are inclusive of motor vehicles in general. Such motor vehicles may encompass passenger automobiles including sport utility vehicles (SUVs), buses, trucks, various commercial vehicles, watercraft including a variety of boats and ships, aircraft, and the like. Such motor vehicle may also include hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example, vehicles powered by both gasoline and electricity.

The above and other features of the disclosure are discussed below.

### BRIEF DESCRIPTION OF THE DRAWINGS

The above and other features of the present disclosure are described in detail below with reference to certain embodiments thereof illustrated in the accompanying drawings, which are given hereinbelow by way of illustration only, and thus are not limitative of the present disclosure, and wherein:

FIG. 1 is a partial cross-sectional view of an axial flux motor, according to an embodiment of the present disclosure;

FIG. 2 is a view showing a stator of the axial flux motor, according to an embodiment of the present disclosure;

FIG. 3 is a view showing a stator core of the axial flux motor, according to an embodiment of the present disclosure;

FIGS. 4-6 are plan views showing the stator core of the axial flux motor, according to some embodiments of the present disclosure; and

FIG. 7 is a view showing iron loss depending on magnetic flux of a non-oriented electrical steel sheet and a grain-oriented electrical steel sheet, according to an embodiment of the present disclosure.

It should be understood that the accompanying drawings are not necessarily to scale, presenting a somewhat simplified representation of various features illustrative of the basic principles of the disclosure. The specific design features of embodiments of the present disclosure, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Hereinafter, embodiments of the present disclosure are described in detail with reference to the accompanying drawings. Specific structural or functional descriptions made in connection with the embodiments of the present disclosure are merely illustrative for the purpose of describing embodiments according to the concept of the present disclosure/The embodiments according to the concept of the present disclosure may be implemented in various forms. Further, it should be understood that the present description is not intended to limit the disclosure to the described embodiments. On the contrary, the present disclosure is intended to cover not only the described embodiments, but also various alternatives, modifications, equivalents, and other embodiments that may be included within the spirit and scope of the present disclosure as defined by the appended claims.

In the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component or one or more other components may be present therebetween. On the other hand, when the one component is referred to as being “directly connected to” or “directly in contact with” the other component, it should be understood that other components are not present therebetween. Other expressions for the description of relationships between components, e.g., “between” and “directly between” or “adjacent to” and “directly adjacent to”, should be interpreted in the same manner.

The same reference numerals represent the same components throughout the specification. Additionally, the terms in the specification are used merely to describe embodiments and are not intended to limit the present disclosure. In this specification, an expression in a singular form also includes a plural form, unless otherwise clearly specified in context. As used herein, expressions such as “comprise” and/or “comprising” do not exclude the presence or addition of one or more components, steps, operations, and/or elements other than those described. When a component, device, element, or the like of the present disclosure is described as having a purpose or performing an operation, function, or the like, the component, device, or element should be considered herein as being “configured to” meet that purpose or perform that operation or function.

Hereinafter, embodiments of the present disclosure are described in detail with reference to the accompanying drawings.

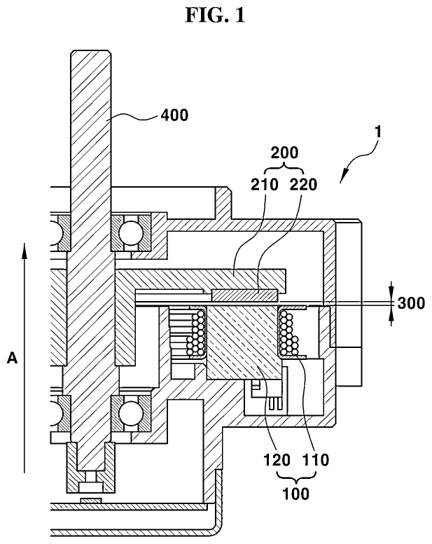

As shown in FIG. 1, an axial flux motor 1 includes a stator 100 and a rotor 200. The stator 100 and the rotor 200 are disposed in an axial direction A of the axial flux motor 1. A gap 300 is provided between the stator 100 and the rotor 200. The gap 300 is disposed between the stator 100 and the rotor 200 in the axial direction A of the axial flux motor 1.

The rotor 200 may be rotated by electromagnetic interaction generated between the stator 100 and the rotor 200. To this end, in some embodiments, the stator 100 includes an electromagnet 110, such as a coil, and the rotor 200 includes a plurality of permanent magnets 220. In another embodiment, each of the stator 100 and the rotor 200 may include an electromagnet.

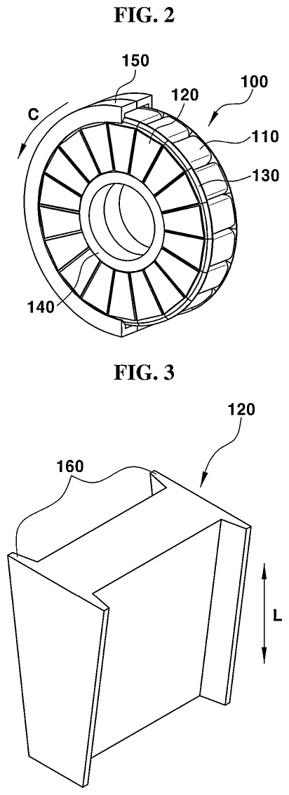

Referring to FIG. 2, the stator 100 includes a stator core 120. The stator core 120 may be formed by disposing divided unit cores in a circumferential direction C of the stator 100. The stator core 120 is wrapped and supported by a reinforcing bobbin 130. The reinforcing bobbin 130 has the electromagnet 110 mounted thereon.

The electromagnet 110 may comprise a coil wound around the stator core 120 or the reinforcing bobbin 130. A current may be applied to the electromagnet 110 from an outside source. A shaft 400 of the axial flux motor 1 may be rotated through attractive force or repulsive force between magnetic flux of the stator 100, the magnetic flux being generated by application of the current, and magnetic flux generated by an electromagnet or a magnet of the rotor 200.

The axial flux motor 1 may further include an inner housing 140 and an outer housing 150. The inner housing 140 and the outer housing 150 may be respectively coupled to an inner side and an outer side of the reinforcing bobbin 130, making it possible to complete the assembly of the stator 100.

As shown in FIG. 3, the stator core 120 may be formed to have a predetermined shape by stacking a plurality of thin plates in a stacking direction L. In some embodiments, the stator core 120 of the axial flux motor 1 is formed of an isotropic material. Isotropy refers to a quality of directional uniformity in a material such that physical properties do not vary in different directions. As a non-limiting example, the isotropic material forming the stator core 120 may be a non-oriented electrical steel sheet or a soft magnetic composite (SMC) material. The stator core 120 of the axial flux motor 1 may be made of a single material to prevent deterioration in efficiency of a portion at which the direction of magnetic flux toward a yoke 160 changes.

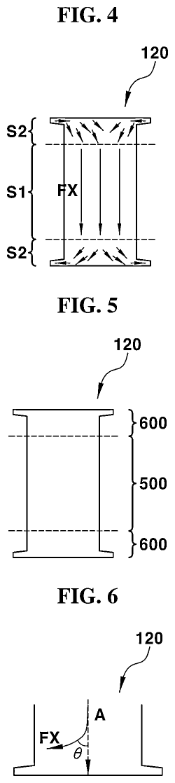

Referring to FIG. 4, when the stator core 120 is made of a single non-oriented electrical steel sheet, characteristics of the isotropic material have a function of preventing efficiency deterioration generated in a curved magnetic flux section S2 having bent magnetic flux FX therein. However, there is a disadvantage in that efficiency deterioration is generated in a straight magnetic flux section S1 in which the magnetic flux FX is formed in a straight line in the stator 100. Accordingly, an object of the present disclosure is to provide the stator 100 of the axial flux motor 1 capable of preventing deterioration in efficiency.

As shown in FIG. 5, the stator core 120 may be divided into a first material region 500 and a second material region 600. The first material region 500 is formed of an anisotropic material, such as a grain-oriented electrical steel sheet. The second material region 600 is formed of an isotropic material, such as a non-oriented electrical steel sheet. Unlike isotropy, anisotropy means that the physical properties of a material vary depending on the direction of the material. In some embodiments, the first material region 500 and the second material region 600 may be bonded to each other using an adhesive. In some embodiments, the first material region 500 and the second material region 600 may be connected to each other using a connection structure therebetween.

The straight magnetic flux section S1 and the curved magnetic flux section S2 may be distinguished by a point at which an angle θ formed by the magnetic flux FX and the axial direction A of the axial flux motor 1 changes from 0°.

According to some embodiments of the present disclosure, the first material region 500 and the second material region 600 may be divided by the above-mentioned point at which the angle θ formed by the magnetic flux FX and the axial direction A of the axial flux motor 1 changes from 0°. The second material region 600, which is a region having the angle θ greater than 0°, may be formed of an isotropic material. The first material region 500, which is a region having the angle θ of 0°, may be formed of an anisotropic material.

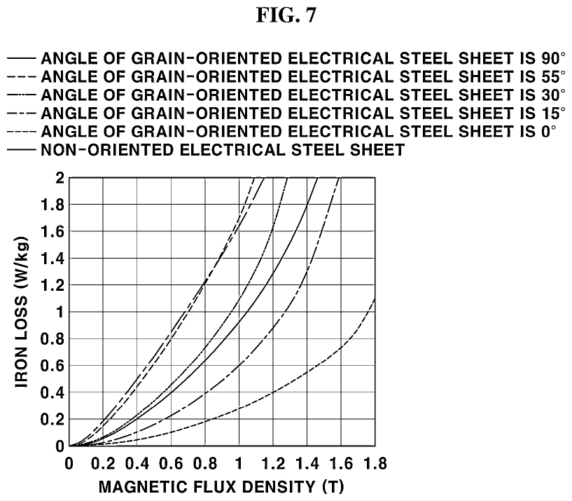

Referring to FIG. 6, according to some embodiments of the present disclosure, in the stator core 120, the first material region 500 and the second material region 600 may be divided by a point at which the angle θ formed by the magnetic flux FX and the axial direction A is a preset angle. The preset angle may be in the range of 10° to 20°, for example about ±15° (i.e., −15° counterclockwise and +15° clockwise with respect to the axial direction A). A portion at which the angle θ formed by the magnetic flux FX and the axial direction A is less than 15° may be formed of an anisotropic material, and a portion at which the angle θ is greater than 15° may be formed of an isotropic material.

Generally, in the stator core 120, a location at which the angle θ formed between the magnetic flux FX and the axial direction A changes varies depending on materials. However, in the non-oriented electrical steel sheet, magnetic properties do not significantly vary depending on the curved magnetic flux angle, whereas in the grain-oriented electrical steel sheet, iron loss increases when the angle θ formed by the magnetic flux FX and the axial direction A is equal to or greater than about 15°. In addition, when the above-mentioned angle θ exceeds 15°, the iron loss of the grain-oriented electrical steel sheet is greater than the iron loss of the non-oriented electrical steel sheet.

Magnetic properties of an anisotropic material are superior to those of an isotropic material based on a rolling direction of the material. For example, magnetic flux density of an anisotropic material may be superior to that of an isotropic material by 25% or more, and the iron loss of an anisotropic material may be decreased by 179% or less. In addition, magnetic properties of an anisotropic material are inferior to those of an isotropic material based on the direction perpendicular to the rolling direction of the material. For example, magnetic flux density of an anisotropic material tends to decrease by about 8% or less, and the iron loss thereof tends to increase by about 77% or more. Overall, in the straight magnetic flux section S1, a grain-oriented electrical steel sheet is about three times more advantageous than a non-oriented electrical steel sheet in terms of iron loss. In the curved magnetic flux section S2, a non-oriented electrical steel sheet is about twice as advantageous as a grain-oriented electrical steel sheet in terms of iron loss.

In consideration of these characteristics, the stator core 120 according to embodiments of the present disclosure is formed of at least two materials. Specifically, the stator core 120 may include both an isotropic material and an anisotropic material. Therefore, according to embodiments of the present disclosure, deterioration in efficiency may be minimized in the curved magnetic flux section S2, and maximum efficiency may be obtained in the straight magnetic flux section S1.

TABLE 1

| | Non-oriented | | | | | |
|---|---|---|---|---|---|---|
| | electrical | | | | | |
| Classification | steel sheet | Grain-oriented electrical steel sheet | | | | |
| Angle | Mixed | 0° | 15° | 30° | 55° | 90° |
| Iron loss (50 Hz, | 2.54 | 0.87 | 2.34 | 3.22 | 3.95 | 4.26 |
| 1.7 T) | | | | | | |
| (watt/kilogram) | | | | | | |
| Remarks for | Comparison | Superior | Superior | Inferior | Inferior | Inferior |
| reference | criteria | | | | | |

Referring to Table 1 and FIG. 7, an analysis has been done on the stator 100 formed of an anisotropic material up to a point at which the magnetic flux angle is less than 150 and formed of an isotropic material at a portion where the magnetic flux angle is equal to or greater than 150. JMAG 2D analysis was performed. Asa material, a rotor “Somalyy_000_3P” and a stator “27PH095+27PNX” was used. Further, a rotational speed was 2,000 revolutions per minute (RPM), and a current (ampere) of each of 0, 50, 100, 200, and 300 was applied.

As a result of the analysis, in comparison with a stator core including a single material, it was confirmed that a stator core including at least two materials as shown in Table 2, showed iron loss reduction of about 23% or more at a same torque level.

TABLE 2

| | | Stator | Stator core | |
|---|---|---|---|---|
| | | core | including | |
| | | including | first material | |
| | | single | region and second | |
| Classification | Conditions | material | material region | Effects |
| Iron loss | 100 A | 190.96 | 159.04 | Improved |
| [W/m³] | | | | by 20% |
| | 300 A | 208.77 | 170.09 | Improved |
| | | | | by 23% |
| Power | 100 Nm | 543.69 | 537.7 | Equivalent |
| [newton] | | | | level |
| | 300 Nm | 1637.82 | 1636.62 | Equivalent |
| | | | | level |

According to embodiments of the present disclosure, the iron loss of an axial flux motor is greatly reduced by significantly increasing efficiency of a straight magnetic flux section of a stator core, thereby making improving efficiency of the axial flux motor.

Although the stator according to embodiments of the present disclosure is described herein as being for an axial flux motor, the stator according to embodiments of the present disclosure may be applied not only to an axial flux motor but also to a radial flux motor.

As is apparent from the above description, the present disclosure provides an axial flux motor having improved efficiency.

The effects of the present disclosure are not limited to the above-mentioned effects. Other effects not mentioned herein should be understood by those having ordinary skill in the art from the detailed description of the embodiments.

The present disclosure is not limited by the above-described embodiments and accompanying drawings. It should be apparent to those having ordinary skill in the art that various substitutions, modifications, and changes may be made within the scope of the technical idea of the present disclosure.

What is claimed is:

1. A stator of a motor, the stator comprising a stator core at least partially formed of an anisotropic material.

2. The stator of claim 1, wherein the stator core comprises:
a straight magnetic flux section having a magnetic flux formed parallel to an axial direction of the stator core; and
a curved magnetic flux section having an angle formed by the magnetic flux and the axial direction of the stator core,
wherein the straight magnetic flux section is formed of the anisotropic material and the curved magnetic flux section is formed of an isotropic material.

3. The stator of claim 1, wherein the stator core comprises:
a first material region formed of the anisotropic material; and
a second material region formed of an isotropic material.

4. The stator of claim 3, wherein the first material region and the second material region are partitioned based on a direction of a magnetic flux formed in the stator core.

5. The stator of claim 4, wherein the second material region has an angle between the magnetic flux and an axial direction of the stator core.

6. The stator of claim 5, wherein the angle is in a range of 10° to 20°.

7. The stator of claim 6, wherein the angle is 15°.

8. The stator of claim 2, wherein:
the isotropic material is a non-oriented electrical steel sheet or a soft magnetic composite (SMC) material; and
the anisotropic material is a grain-oriented electrical steel sheet.

9. The stator of claim 1, wherein the stator core has a coil wound therearound.

10. An axial flux motor comprising:
a rotor including a plurality of permanent magnets; and
a stator disposed in an axial direction of the rotor and the axial flux motor, the stator including a stator core having a coil mounted thereon, wherein the stator core is at least partially formed of an anisotropic material.

11. The axial flux motor of claim 10, wherein the stator core comprises:
a first material region formed of the anisotropic material; and
a second material region formed of an isotropic material.

12. The axial flux motor of claim 11, wherein the first material region and the second material region are partitioned based on a direction of a magnetic flux formed in the stator core.

13. The axial flux motor of claim 12, wherein the magnetic flux has an angle with respect to the axial direction of the axial flux motor in the second material region.

14. The axial flux motor of claim 13, wherein the angle is in a range of 10° to 20°.

15. The axial flux motor of claim 10, wherein the stator core comprises:
a straight magnetic flux section where a magnetic flux is formed parallel to the axial direction of the axial flux motor; and
a curved magnetic flux section where an angle is formed by the magnetic flux and the axial direction thereof,
wherein the straight magnetic flux section is formed of the anisotropic material and the curved magnetic flux section is formed of an isotropic material.

16. The axial flux motor of claim 15, wherein:
the isotropic material is a non-oriented electrical steel sheet or a soft magnetic composite (SMC) material; and
the anisotropic material is a grain-oriented electrical steel sheet.

17. The axial flux motor of claim 10, wherein the stator comprises:
a bobbin disposed to surround the stator core, wherein the coil is wound around the coil; and
a first housing and a second housing respectively mounted on a first side of the bobbin and a second side thereof.

18. The axial flux motor of claim 10, further comprising a shaft configured to rotate with the rotor and formed to pass through the stator.
